(19) United States
(12) Patent Application Publication
(10) Pub. No.: US 2004/0073688 A1
(43) Pub. Date: Apr. 15, 2004

(54) Electronic payment validation using Transaction Authorization Tokens

(76) Inventor: Scott E. Sampson, Orem, UT (US)

Correspondence Address: STOEL RIVES LLP, One Utah Center, 201 South Main Street, Suite 1100, Salt Lake City, UT, 84111, US

(21) Appl. No.: 10/671,087

(22) Filed: Sep. 25, 2003

Related U.S. Application Data
(63) Continuation-in-part of application No. 10/382,042, filed on Mar. 5, 2003.
(60) Provisional application No. 60/415,321, filed on Sep. 30, 2002.

(51) Int. Cl. G06F 15/16; G06F 17/60

(52) U.S. Cl. 709/229; 705/65

(57) ABSTRACT

An account holder initiates a transaction by providing a vendor both account information as well as a specific Transaction Authorization Token (TAT) that was previously stored in a Token Log. The vendor passes the account information and TAT with the transaction information to an institution responsible for authorizing one or more transactions involving the financial account. That institution determines whether or not to authorize the transaction by consulting the Token Log entry for the given TAT.

### RELATED APPLICATIONS

This application is related to and claims the benefit of U.S. Provisional Application No. 60/415,321, filed Sep. 30, 2002, for “Function and Use of a Token Action Log,” with inventor Scott E. Sampson, which application is incorporated herein by reference in its entirety. This application is also a continuation-in-part of U.S. patent application Ser. No. 10/382,042, filed Mar. 5, 2003, for “Communication Management Using a Token Action Log,” with inventor Scott E. Sampson, which application is likewise incorporated herein by reference in its entirety.

### COPYRIGHT NOTICE

© 2003 Scott E. Sampson. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71 (d).

### TECHNICAL FIELD

The present invention relates generally to payment systems. More specifically, the present invention relates to a system and method for authorizing electronic transactions.

### BACKGROUND OF THE INVENTION

Increasingly, the majority of financial transactions in the developed world are being made electronically. Electronic transactions have many advantages over nonelectronic transactions, such as greater efficiency. However, electronic transactions also introduce new opportunities for fraud.

When hard currency is stolen it is physically stolen. However, with electronic transactions, thieves need to obtain little more than the victim's account number in order to have access to the funds. This area of thievery fits within the realm of so-called “identity theft,” where the thief acts as though he or she were the account holder in electronically accessing the funds belonging to the account holder.

One form of protection has been written signatures, which are not always required, particularly with online transactions. Another form of protection is Personal Identification Numbers (PINs), which can also be stolen almost as easily as account numbers.

### SUMMARY OF THE INVENTION

The present invention provides a system and method for preventing identity theft and other forms of fraud with respect to financial transactions. When a person initiates a financial transaction, he or she simultaneously initiates authorization of that transaction by creating and/or accessing a Transaction Authorization Token (TAT). The TAT is a symbol that is stored in a Token Log (also referred to herein as a Token Action Log). The Token Log also contains conditions for transactions associated with specific TAT entries. The Token Log is accessible by, for example, the financial institution holding the account on which the financial transaction will be based, either by direct access or by polling the device or system that stores the Token Log.

At the time of the transaction, the account holder provides the vendor (typically a product seller or service provider) with the account number and with a selected TAT. The vendor communicates that information to the financial institution in order to authorize the transaction. The financial institution determines whether to authorize the transaction by checking the transaction information against conditions recorded in the Token Log for the given TAT.

In one embodiment, the financial institution checks for a valid TAT by “polling” the account holder's communication device, e.g., sending an inquiry message and expecting a reply. In such an embodiment, the TAT may be stored in a Transaction Log on the account holder's communication device. The polling inquiry message may include an indication of transaction details, such as the transaction amount, the vendor's name, etc.

The communication device may then check those details against parameters stored with the TAT in the Token Log. For example, a TAT may only be valid for transactions less than a particular monetary amount. The communication device may respond to the polling inquiry with an indication that the transaction is either authorized or not authorized. The communication device may also note that the particular TAT has been accessed, and, if specified as single-use, that the particular TAT can no longer be used to authorize transactions. Other TATs may be designated to be able to authorize a specific number of transactions, or even an infinite number of transactions.

In another embodiment, the TAT can be transmitted to the financial institution prior to or shortly after the transaction is initiated. The TAT might be accompanied by parameters that specify conditions of the transaction (e.g., maximum dollar amount, pattern match for the vendor's name, etc.). The financial institution then uses that TAT and accompanying parameters to verify the transaction. In this case, the TAT might be temporarily stored by the financial institution.

In yet another embodiment, the TAT can be stored at a location separate from either the account holder's communication device or the financial institution's computer systems. In this embodiment, the financial institution would check for a valid TAT by polling this third-party organization's computer system similar to the polling method described above.

When a token is checked against the conditions recorded in the Token Log, the system may also initiate other actions that are configured in the system. For example, the Token Log entry for the given token might contain information about the nature of the transactions, i.e., that it was for a business expense and perhaps even the category of the expense (lodging, meals, etc.). If the token designates a business expense, the system may be configured to automatically notify the company that a business expense of a given category has been incurred. This could simplify the process of tracking business expenses, since employees would designate the nature of the expense at the time the given token is stored in the Token Log.

In general, the Token Log may contain information in addition to the token and the corresponding transaction conditions, which additional information might be used in other activities pertaining to the transaction besides simply authorizing the transaction.

Another example is an account holder who desires to be notified when a given transaction is checked against the Token Log entry. He or she may record information in the Token Log indicating that an email message is to be sent to a given address when a transaction is validated by the given token.

The Token Log entry may contain information that initiates action some time after the time that the given transaction is checked against the entry. For example, if a Token Log entry contains information about the category of the transaction (e.g., business-related, tax deductible, food, etc.), the financial institution could use that information to later provide categorically-organized statements to the account holder.

The general concept is that token entries in a Token Log, besides being associated with conditions for given transactions, may also contain information about other actions besides simply authorizing transactions. It is for this reason that a Token Log may be also be called a Token Action Log, containing tokens and corresponding action information.

One aspect of this invention is that it may require, with possible exceptions, that the account holder authorize the transaction through a communication channel that is distinct from the transaction interaction with the vendor. The financial institution may thus require, with possible exceptions, that a valid TAT entry in a Token Log be consulted before a given transaction is fully processed.

The possible exceptions to requiring a valid TAT to authorize transactions allow for the cases where, for instance, communication between the account holder's communication device and the financial institution is not practical or possible, and the financial institution or third-party Token Log administrator does not already have a TAT for the transaction.

As an example, the communication device might be embodied as a cell phone, and the account holder might want to conduct a financial transaction at a location outside of the cell phone's calling area. In such cases, exceptions to requiring TAT authorization can be pre-arranged between the account holder and the financial institutions.

As a further example, a pre-arranged exception might specify that up to three transactions totaling less than $500 may be processed without validation from a TAT. In one embodiment, the financial institution's or third-party's Token Log may previously store a token and conditions specifically designated for transactions that do not otherwise accompany a token.

Alternatively, the out-of-communication account holder might give a merchant a TAT that was previously stored in the Token Log at the financial institution or third-party Token Log administrator. In this way, the account holder does not need to be in communication with the keeper of the Token Log at the time of the transaction, but can simply recall the TAT that was previously stored. The account holder might keep one or more previously stored TATs on his or her person for such instances, such as in a portable electronic device, on a piece of paper, or in his or her mind.

Additional aspects of the present invention will be apparent from the following detailed description of preferred embodiments, which proceeds with reference to the accompanying drawings.

### BRIEF DESCRIPTION OF THE DRAWINGS

FIG. 1 is a block diagram of components of a system in accordance with an embodiment of the invention;

FIG. 2 is a basic flowchart of how transaction authorization tokens (TATs) are used to authorize transactions;

FIG. 3 is a block diagram of a configuration of a Token Log.

FIG. 4 shows an application of the TAT system using an account holder's cell phone to create tokens;

FIG. 5 is a continuation of FIG. 4 that illustrates an attempted fraud.

### DETAILED DESCRIPTION

In the following description, well-known structures, materials, or operations are not shown or not described in detail to avoid obscuring aspects of the invention. Furthermore, the described features, structures, or characteristics may be combined in any suitable manner in one or more embodiments.

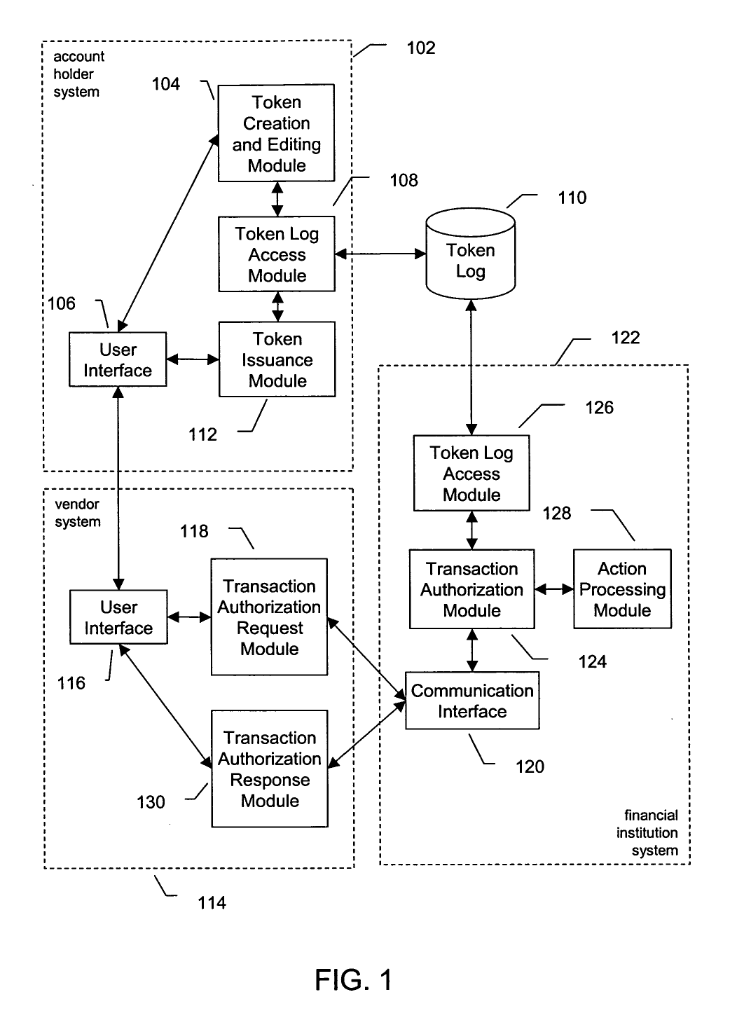

FIG. 1 shows a block diagram of a system in accordance with an embodiment of the invention. In one embodiment, an account holder system 102 includes a token creation and editing module 104, which is, in turn, controlled by a user interface 106. As used herein, the term “account holder” may also refer to a user authorized by the account holder.

When the user initiates the creation or editing of a token or token settings, a token log access module 108 stores the token and settings in a Token Log 110. In FIG. 1, the Token Log 110 is shown separate from the account holder system 102, the vendor system 114, and the financial institution system 122. In other embodiments, however, the Token Log 110 may be either part of the account holder system 102, part of the financial institution system 122, or part of a third-party system. Throughout this disclosure, the term “financial institution” may refer to an entity designated by a financial institution to authorize transactions on its behalf.

When the user specifies that a token should be issued, a token issuance module 112 retrieves a token as appropriate via the token access module 108. In some instances, the user will request the issuance of a token that is not already in the Token Log, in which case the token will be both created and issued.

As illustrated, the token issuance module 112 may present the token to be issued via the user interface 106, so that the user can pass the token to the vendor's user interface 116. However, in another embodiment, the token issuance module 112 may interface directly with the vendor system 114, and thereby pass the specific TAT for the given transaction without user interaction.

When the vendor receives a token and accompanying account number information, it is entered, in one embodiment, via the vendor's user interface 116. That information is then combined with other transaction information, such as the transaction amount. The transaction authorization request module 118 communicates that information to the financial institution's system 122.

When the financial institution receives the transaction information (and TAT) via a communication interface 120, it is processed by a transaction authorization module 124, with the purpose of determining whether the transaction should be authorized. The transaction authorization module 124 accomplishes this by having a token log access module 126 look up conditions and actions associated with the token in the Token Log 110. The transaction authorization module 124 uses that information to determine whether or not the transaction should be authorized. That determination is communicated via the communication interface 120 back to the vendor's transaction authorization response module 130, which has the responsibility of informing the vendor 116 of the outcome.

In some embodiments, the financial institution's transaction authorization module also initiates other actions associated with the given token by use of an action processing module 128. Examples of such actions are provided above and include notifying the account holder or some other entity that the token has been used to authorize or reject a given transaction.

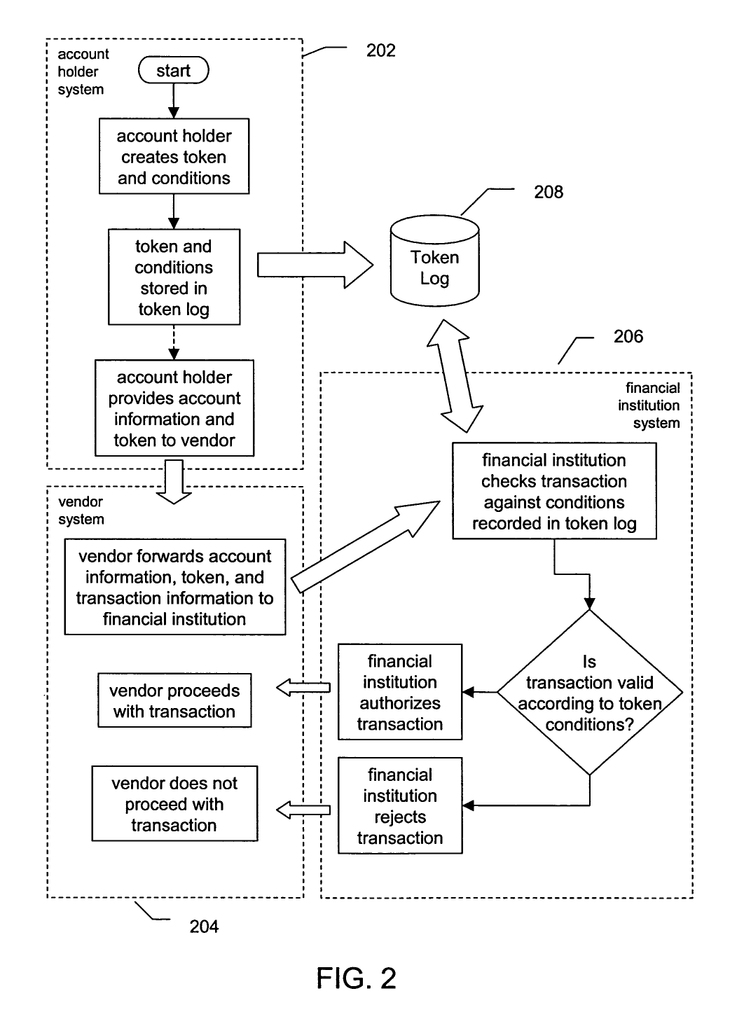

FIG. 2 is a basic flowchart of how TATs can be used to authorize financial transactions and prevent fraud. The diagram is broken down into three areas of action: account holder actions 202, vendor actions 204, and financial institution actions 206. The actual Token Log 208 is shown separate from these action areas, since in different embodiments the Token Log may reside with the account holder, with the financial institution, or with some third-party.

The account holder starts his or her actions 202 by creating a token and corresponding financial transaction conditions which are then stored in a Token Log until the time they are used to authorize a transaction. The token may be created and stored days or months before a transaction, moments before a transaction, or during a transaction. This undefined time lag is represented by the dashed line to the step in which the account holder provides the account information and a token to a vendor. The account information generally includes the account type and the account number. The account number might be a credit card number, a debit card number, etc.

The vendor actions 204 continue with the vendor receiving the account information and token from the account holder, and forwarding it with transaction information to the financial institution. Transaction information may include the amount of the transaction and the vendor's identification. In one embodiment, the financial institution is a credit card processor.

A primary action of the financial institution 206 is to authorize or not authorize the transaction, as appropriate. The financial institution determines if the transaction is appropriate by consulting the Token Log according to the given token. For the given token, the Token Log indicates any conditions that are required for transactions accompanying that token. Example conditions include the following:

The monetary amount of the transaction cannot be greater than a specified amount.

The date of the transaction has to be before or after a given date.

The transaction must be at least a specified number of days from a prior transaction or event.

The vendor's name must match a specific pattern.

The token could not have been used to authorize more than a specified number of prior transactions.

The conditions recorded in the Token Log are typically determined by the account holder. However, in other embodiments the conditions might be specified by the financial institution or be specified as defaults within the Token Log.

The financial institution consults the Token Log either by direct access to the Token Log or by polling the system that controls the Token Log. Either way, the objective is for the financial institution to determine whether the transaction is authorized. If it is authorized, the financial institution may notify the vendor, so that the vendor may proceed with the transaction. If the transaction is not authorized, the financial institution may also notify the vendor of such so that the transaction may be halted.

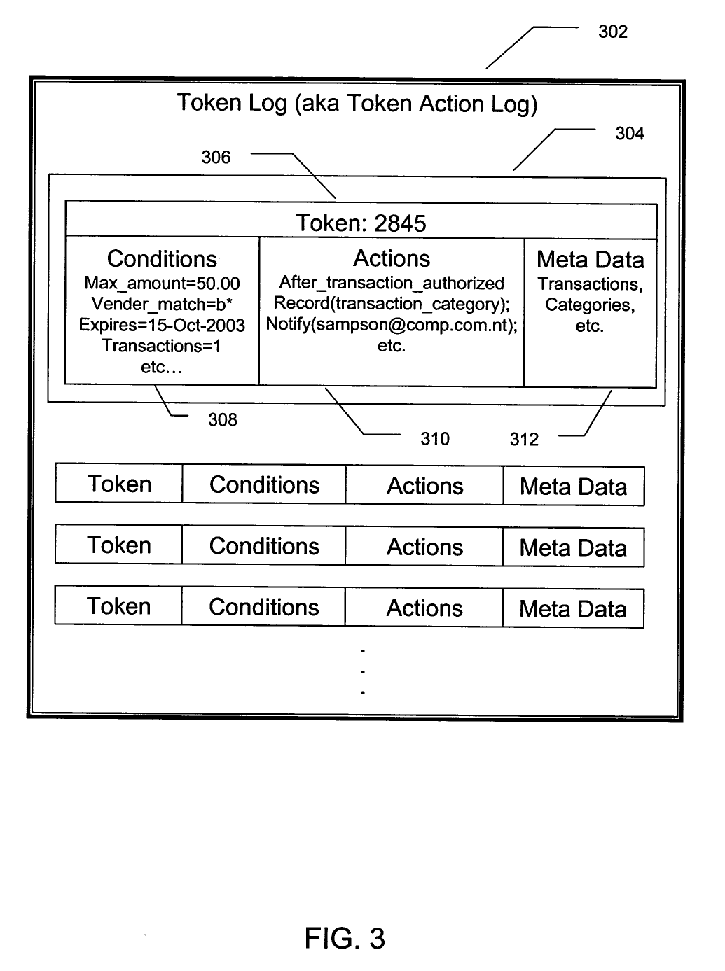

FIG. 3 shows a block diagram of a configuration of a Token Log. The Token Log 302 may be embodied as a data structure that associates tokens with relevant information. For example, a Token Log entry 304 includes a token 306 that is the arbitrary symbol “2945.” Note that the specific format of tokens is not restricted in this invention, and they could contain digits, alphabetic characters, or other symbols. An advantage of using numerical digits is that they can be entered in the numeric keypads that many vendors already use for authorizing credit card transactions.

The example token entry 304 also includes information about the conditions 308 required of a transaction to be authorized. In this example, the transaction amount is limited to no more than 50 dollars, the vendor's name must start with the letter “b,” the token will only authorize transactions before 15-Oct.-2003, it will only authorize at most one transaction, etc.

The example token entry 304 also includes information about other actions 310 that are to be performed at the time the given token is used to authorize a transaction. The inclusion of other actions is why Token Logs are also called “Token Action Logs.” Moreover, the entry may include meta data 312, which is other information pertaining to the token, such as the number of transactions it has been used to authorize, the categories of those transactions, etc. Beneath the example entry 304 are three other entries, illustrating that multiple tokens and corresponding information are recorded in a Token Log 302.

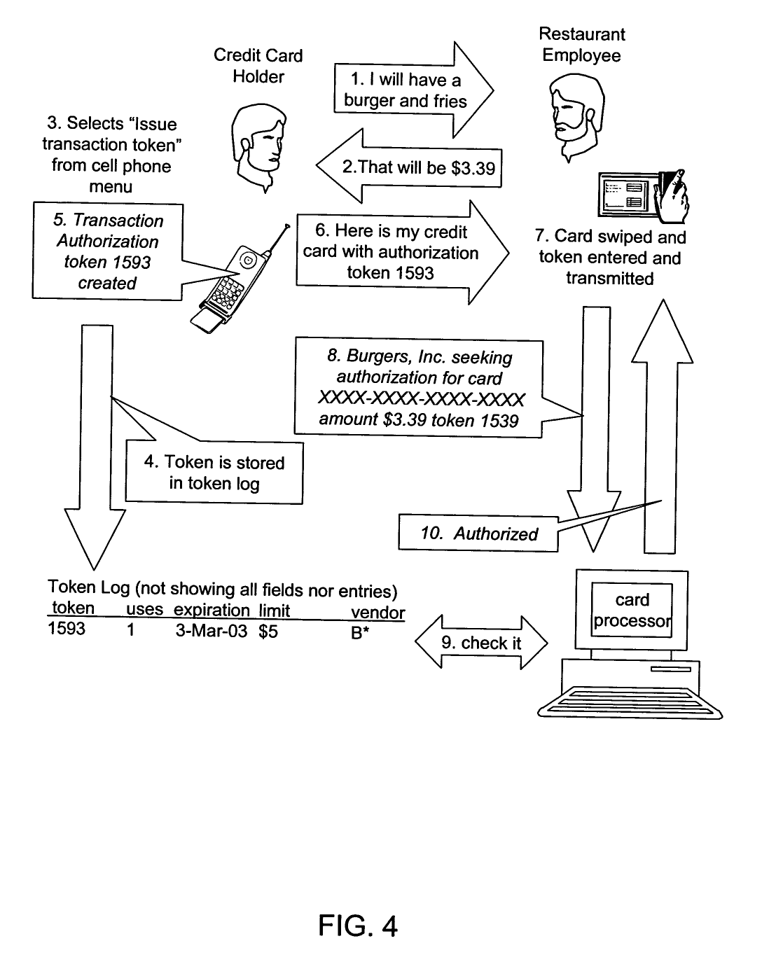

FIG. 4 shows one embodiment of the TAT system in which the account is a credit card account and the account holder uses his or her cell phone to create and store tokens. Note that tokens could be just as easily created on a computer or some other device. For this example, the account holder creates the token at the time of the transaction. Alternatively, the account holder could use a token that was previously created and stored in the Token Log.

The steps for the FIG. 4 example are numbered within each block of the diagram, and are described as follows:

Step 1: The account holder orders his meal.

Step 2: The restaurant employee indicates the price ($3.39).

Step 3: The account holder creates a TAT using his cell phone by using a software function of the phone. Techniques for programming a cell phone are known in the art. Note that the account holder could use a previously created token or create a new token just for this transaction. In this example, he or she creates a new token and specifies conditions: one use on or before 3-Mar.-2003 with a $5 limit from a vendor whose name starts with the letter “B.” In this example, the cell phone software comes up with the token (e.g., “1593”) as an arbitrary sequence of four digits. Of course, any number of digits or other type of code may be used within the scope of the invention.

Step 4: The cell phone stores the TAT in the Token Log, which may be kept in the cell phone or may be kept at a remote location (e.g., central server). There are various means for sending the token to a remote location, one of which is to send it as part of a specially formatted text message (e.g., via SMS) to the keeper of the Token Log. The message might be formatted as XML or as some other structure. Regardless, the TAT is stored in a Token Log, which is organized using any suitable data structure.

Step 5: The cell phone displays the TAT for the account holder so that he or she can pass it to the vendor.

Step 6: The account holder gives the credit card to the vendor with the created TAT.

Step 7: The restaurant employee runs (“swipes”) the card through the merchant card reader and types in the given TAT.

Step 8: The card reader transfers the information to the credit card processing organization, which is the “financial institution” for this scenario. The transferred information includes the vendor's name and/or identifier, the credit card number, the transaction amount, and the given TAT. Although not illustrated as such in the figure, this information may be formatted in XML or some other structured format.

Step 9: The credit card processing organization checks the TAT against the information in the Token Log. If the Token Log is stored in the account holder's cell phone, then the card processor might poll that phone by sending a short-text message to the account holder's cell phone that triggers the cell phone to automatically check the Token Log conditions. Such a message could alternatively be sent to a third party responsible for keeping the Token Log. If the Token Log is kept by the card processor, then the card processor's computer system can directly check the specific token conditions in the Token Log.

Step 10: Since this example shows a legitimate transaction that meets the token conditions, the card processor can report back to the vendor (to the restaurant's card device) that the transaction is authorized. The restaurant employee can then complete the transaction, and serve the burger and fries. When systems are functioning properly, the entire authentication process may take a few seconds or less.

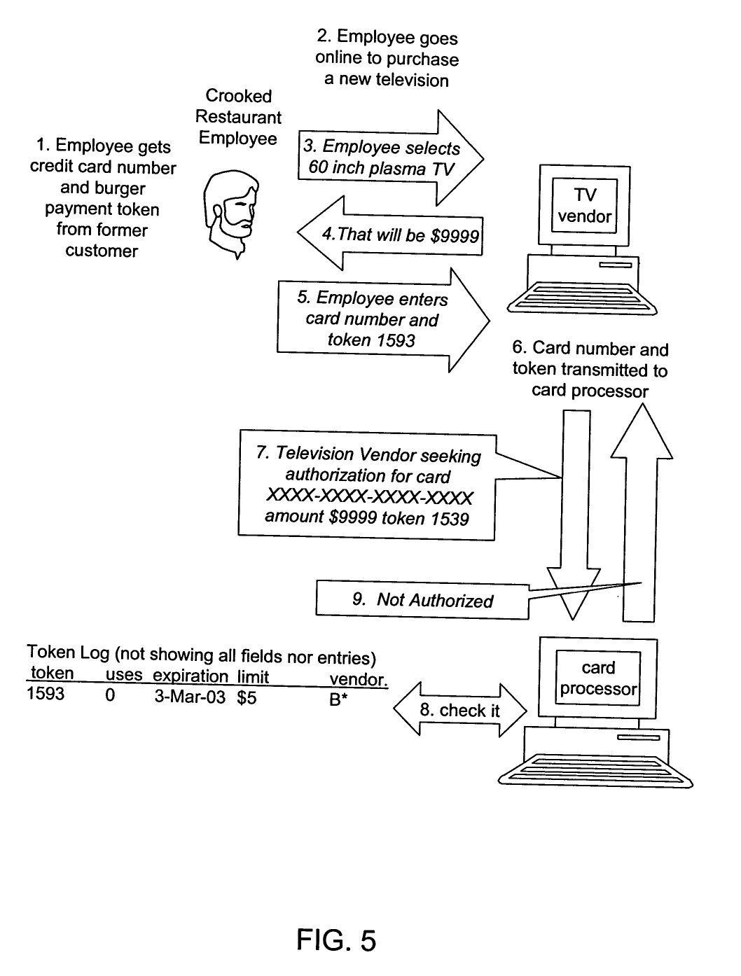

FIG. 5 continues the example of FIG. 4 in the situation wherein the restaurant employee attempts to fraudulently use the account holder's credit card to purchase a big-screen television from an online vendor. Steps of this scenario are as follows:

Step 1: The employee gets the account holder's credit card number from the account holder who used it at the restaurant. The employee realizes that this card requires TATs for authorization, so simultaneously gets the TAT that was created for the restaurant transaction.

Step 2: The employee locates a television vendor on the Internet.

Step 3: The employee selects a top-of-the-line plasma TV to purchase.

Step 4: The online TV vendor website reports a price of $9999.

Step 5: The employee navigates to the check-out portion of the website and enters the stolen credit card number and TAT.

Step 6: The vendor computer automatically transmits the appropriate transaction information to the credit card processor for authorization. Step 7 illustrates an example of that information, although in actual application the information may be formatted in XML or some other structured format.

Step 8: The credit card processor checks the token and transaction information against the Token Log, such as by one of the methods described in the description of FIG. 4. In this case, the transaction information does not match up to the conditions of the token. The token has already been used to authorize one transaction, and it was previously set to only authorize one transaction. Further, the amount exceeds the limit of $5, and the vendor's name does not start with the letter “B.”

Step 9: Since the transaction conditions are not met, the card processor notifies the TV vendor that the transaction is not authorized, so that the TV vendor can cancel the transaction and not ship the television to the employee.

Note that the example described in FIGS. 4 and 5 shows simply one embodiment of the invention. This invention does not limit the embodiments to using cell phones or computers as the devices to create and/or transmit tokens. Nor does the invention limit the means or location with which the tokens are stored in the Token Log, nor how the Token Log is checked for a given token accompanying a given transaction. Those skilled in the art will see that there are many methods and data structures that can be used for these functions.

Based on the foregoing, the present invention offers numerous advantages not found in conventional approaches. For instance, the present invention protects account holders from identity theft and unauthorized use of account funds. If a dishonest person steals the account holder's account number, it would be useless without also having the ability to produce valid tokens that are in the Token Log. If tokens are generated by, for example, the account holder's cell phone then it may appear that stealing the account number and the cell phone could result in identity theft and unauthorized use of account funds. The solution is to require the user of the cell phone enter a special code before tokens are generated or accessed. The person stealing the cell phone would not have that code, and thus would not be able to produce TATs.

The invention also protects financial institutions who usually assume some liability for transactions involving stolen account information. Further, it protects vendors who can be liable for charge-back of transactions involving fraud.

An additional advantage to vendors can occur by improving the opportunity to have non-repudiation of transactions. For example, if an online vendor ships a product to a customer who pays online with a credit card, that customer might later dispute the transaction with the credit card processor, claiming that he never ordered the product, and that someone must have stolen his credit card number. However, the vendor may have required that such transactions can only be paid for online with a TAT that allows a non-repudiation condition. That way, checking the Token Log includes checking that the transaction cannot be reversed by the customer without the vendor's approval.

What is claimed is:

1. A method comprising:
associating a plurality of tokens with a financial account by recording the plurality of tokens in a token log, which token log is accessible by an institution that is responsible for authorizing one or more transactions involving the account; and
initiating a transaction involving the financial account by providing one of the tokens and an indication of the account to a vendor, wherein the vendor is to provide the token, the indication of the account, and information about the transaction to the authorizing institution, which authorizing institution provides the vendor with transaction authorization based on the token being found to exist in the token log.

2. The method of claim 1, further comprising:
receiving the token, the indication of the account, and the transaction information from the vendor;
checking whether the token exists in the token log; and
notifying the vendor that the transaction is authorized based on the token being found to exist in the token log.

3. A method comprising:
associating a token with one or more conditions in a token log that is accessible by an institution that is responsible for authorizing one or more transactions involving a financial account; and
initiating a transaction involving the financial account by providing the token and an indication of the account to a vendor, wherein the vendor is to provide the token, the indication of the account, and information about the transaction to the institution responsible for authorizing that transaction, which authorizing institution provides the vendor with transaction authorization based on the one or more conditions associated with the token in the token log being satisfied.

4. The method of claim 3, further comprising:
receiving the token, the indication of the account, and the transaction information from the vendor;
checking whether the token exists in the token log; and
notifying the vendor that the transaction is authorized based on the token being found to exist in the token log.

5. A method comprising:
receiving from an account holder an indication of one or more conditions for completing one or more transactions;
associating a token with the one or more conditions in a token log that is accessible by an institution that is responsible for authorizing one or more transactions involving a financial account; and
initiating a transaction involving the financial account by providing the token and an indication of the account to a vendor, wherein the vendor is to provide the token, the indication of the account, and information about the transaction to the institution responsible for authorizing that transaction, which authorizing institution provides the vendor with transaction authorization based on the one or more conditions associated with the token in the token log being satisfied.

6. The method of claim 5, further comprising:
receiving the token, the indication of the account, and the transaction information from the vendor;
checking whether the one or more conditions associated with the token in the token log are satisfied; and
notifying the vendor that the transaction is authorized responsive to the one or more conditions being satisfied.

7. The method of claim 5, wherein the indication of the account is one of a credit card number, a debit card number, an online payment number, a merchant account number, and a bank account number.

8. The method of claim 5, wherein the token log comprises a data structure that associates specific tokens with one or more specific transaction conditions.

9. The method of claim 5, wherein a transaction condition includes a maximum monetary amount for one or more specific transactions.

10. The method of claim 5, wherein a transaction condition includes a pattern to match a name of the vendor for one or more specific transactions.

11. The method of claim 5, wherein a transaction condition includes a time-frame in which one or more specific transactions are to be completed.

12. The method of claim 5, wherein a transaction condition includes a number of times a specific token may be used to authorize transactions.

13. The method of claim 5, wherein a transaction condition includes a minimum time interval between uses of a specific token to authorize transactions.

14. The method of claim 5, wherein a transaction condition includes the existence of a specific token in the token log.

15. The method of claim 5, wherein a transaction condition includes a mechanism for non-repudiation of the financial transaction.

16. The method of claim 6, wherein the token log is stored in a communication device of the account holder.

17. The method of claim 16, wherein the communication device is one of a telephone, a cell phone, a desktop computer, and a portable computing device.

18. The method of claim 16, wherein checking whether the at least one condition associated with the token in the token log is satisfied is accomplished by polling the account holder's communication device.

19. The method of claim 18, wherein polling the account holder's communication device comprises:
sending to the account holder's communication device a structured message containing transaction information and the specific token; and
receiving from the account holder's communication device a structured message indicating whether the transaction is approved or denied based on the satisfaction of the one or more conditions.

20. The method of claim 18, wherein polling the account holder's communication device includes:
sending to the account holder's communication device a structured message containing the specific token;
receiving from the account holder's communication device information from the token log pertaining to the given token; and
using the information to determine if the transaction should be approved or denied.

21. The method of claim 6, wherein the token log is stored at the location of the institution responsible for authorizing one or more transactions involving the financial account.

22. The method of claim 6, wherein the token log is stored at a third-party location accessible to both the account holder and the institution responsible for authorizing one or more transactions involving the financial account.

23. The method of claim 6, wherein the vendor is one of a seller of physical goods, a seller of services, a charitable organization, and an organization to which the account holder owes money.

24. The method of claim 5, wherein associating one or more tokens includes receiving the at least one condition for the one or more tokens from an external source.

25. The method of claim 5, wherein entries in the token log include an indication of a type of transaction corresponding to one or more specific tokens.

26. The method of claim 5, further comprising automatically creating one or more token within a communication device of the account holder.

27. The method of claim 5, wherein providing the token to a vendor includes entering a pass code in order to access the desired token.

28. The method of claim 5, wherein providing the token to a vendor includes presenting a token that is known by the account holder to have been previously stored in the token log.

29. A method comprising:
receiving transaction information from a vendor, which transaction information is not accompanied by a token;
associating the transaction with a special token that is designated for transactions that are not otherwise accompanied by a token;
checking the special token against information in a token log in order to verify that the transaction is authorized and within one or more conditions associated with the special token.

30. The method of claim 29, wherein the account holder defines the one or more conditions associated with the special token which is designated for transactions that are not otherwise accompanied by a token.

31. A system comprising:
a token creator to enter and store one or more tokens;
a token log to associate specific tokens with specific conditions under which specific financial transactions will be valid; and
a token access sub-system to make one or more tokens available to an account holder for distribution to one or more vendors involved in transactions pertaining to an account of the account holder, wherein each vendor is to provide a specific token, an indication of the account, and information about a transaction to an institution responsible for authorizing one or more transactions involving the account, which institution authorizes each vendor to complete each vendor's transaction responsive to the specific conditions associated with each specific token in the token log being satisfied.

32. The system of claim 31, wherein the indication of an account is one of a credit card number, a debit card number, an online payment number, a merchant account number, and a bank account number.

33. The system of claim 31, wherein the token log comprises a data structure that associates specific tokens with one or more specific transaction conditions.

34. The system of claim 31, wherein the specific conditions include a maximum monetary amount for one or more specific transactions:

35. The system of claim 31, wherein the specific conditions include a pattern to match a name of the vendor for one or more specific transactions.

36. The system of claim 31, wherein the specific conditions include a time-frame in which one or more specific transactions are to be completed.

37. The system of claim 31, wherein the specific conditions include a number of times a specific token may be used to authorize transactions.

38. The system of claim 31, wherein the specific conditions include a minimum time interval between uses of a specific token to authorize transactions.

39. The system of claim 31, wherein the specific conditions include the existence of a specific token in the token log.

40. The system comprising:
a communication interface for receiving a token, an indication of an account, and information about a transaction from a vendor;
a transaction authorization module for checking whether at least one condition associated with the token in the token log is satisfied;
wherein the communication interface is to notify the vendor that the transaction is authorized responsive to the at least one condition being satisfied.

41. An apparatus comprising:
means for storing one or more tokens in a token log;
means for associating each token with conditions under which specific financial transactions are valid;
means for accessing tokens so that they can be associated with specific financial transactions; and
means for authorizing specific transactions by verifying that the conditions for the tokens associated with the specific transactions are met.

42. A computer-readable medium comprising:
program code for receiving from an account holder an indication of one or more conditions for completing one or more transactions;
program code for associating a token with the one or more conditions in a token log that is accessible by an institution that is responsible for authorizing one or more transactions involving a financial account; and
program code for facilitating the initiation of a transaction involving the financial account by providing the token and an indication of the account to a vendor, wherein the vendor is to provide the token, the indication of the account, and information about the transaction to the institution responsible for authorizing that transaction, which authorizing institution provides the vendor with transaction authorization based on the one or more conditions associated with the token in the token log being satisfied.

43. The computer-readable medium of claim 42, further comprising:
program code for receiving the token, the indication of the account, and the transaction information from the vendor;
program code for checking whether the one or more conditions associated with the token in the token log are satisfied; and
program code for notifying the vendor that the transaction is authorized responsive to the one or more conditions being satisfied.
